(19) United States
(12) Patent Application Publication
(10) Pub. No.: US 2009/0213009 A1
(43) Pub. Date: Aug. 27, 2009

(54) POSITION DETECTION SYSTEM, POSITION DETECTION SERVER, AND TERMINAL

(75) Inventors: Yousuke ISHIWATARI, Tokyo (JP); Junshiro Kanda, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/143,145

(22) Filed: Jun. 20, 2008

(30) Foreign Application Priority Data
Feb. 25, 2008 (JP) 2008-043233

(51) Int. Cl. G01S 5/14

(52) U.S. Cl. 342/450

(57) ABSTRACT

A position detection server corrects for the attenuation of the intensity of an electric wave from each AP unit which is caused by walls by using map information to determine a distance between each AP unit and a terminal, acquires, as an existence region, a region of the position of the terminal in which variations are permitted to occur in the electric wave intensity due to the characteristics of the electric wave from the distance, restricts this existence region to an actionable region according to the state of the terminal, excludes any part which is blocked by walls when viewed from the immediately preceding position of the terminal from the actionable region by using the map information to determine a movable region, and narrows this movable region down to a region extending in the direction in which the terminal is moving to determine the position of the terminal.

### BACKGROUND OF THE INVENTION

1. Field of the Invention

The present invention relates to a position detection system, a position detection server, and a terminal which receive an electric wave via a network, such as a radio LAN (Local Area Network), so as to acquire the position of a target existing indoors using the intensity of the electric wave.

2. Description of Related Art

Currently, positioning which uses GPS (Global Positioning System) satellites as to outdoor positioning has become mainstream. On the other hand, methods using various devices for indoor positioning have been proposed. Among them, as shown in FIG. 8, there has been proposed a method of receiving an electric wave from a network, such as a radio LAN, by using a device, and carrying out position detection by acquiring a distance from RSSI (Received Signal Strength Indicator which will be referred to as electric wave intensity). In this case, because the intensity of an electric wave is theoretically in inverse proportion to the square of a distance, it is possible to acquire a distance from this relation. However, this theoretical formula is used to calculate a distance in a free space in which no obstruction exists. Therefore, because interference due to reflection of the electric wave actually occurs and attenuation occurs when the electric wave passes through an obstruction, and the intensity of the electric wave can vary due to the characteristics of the electric wave even if the intensity of the electric wave is measured at the same point, the calculated distance may differ from the actual distance. In other words, the position detection using only this theoretical formula includes a large error. As a method for cancelling this error, there has been provided a technology of holding information about the existence of obstructions beforehand, correcting electric wave intensity after acquiring the position of a target from the electric wave intensity, and then correcting the position of the target (for example, refer to patent reference 1). Furthermore, there has been provided a technology of narrowing down the next detected position from the acquired electric wave intensity and a history of the position detection results which have been acquired (for example, refer to patent reference 2).
[Patent reference 1] JP, 2001-349742, A
[Patent reference 2] JP, 2004-112482, A

The above-mentioned conventional methods need to improve the accuracy of the position detection itself in order to correct the position of the target, and, although improvements in the accuracy of the position detection cause the above-mentioned position correction method to produce a good effect, the correction has an opposite effect when already-acquired position detection results include errors. The conventional methods do not take adequate measures against this opposite effect. The most serious problem with the conventional methods is that there is no means for correcting a position detection result even if this position detection result shows that “the target has made a generally-impossible movement.” For example, a detection result showing that the target has passed through a wall through which any target cannot pass may be acquired as a result of a change in the electric wave intensity. Therefore, the accuracy of the position detection falls and the accuracy of subsequent position detection results also falls gradually. Furthermore, a problem with the technology disclosed by patent reference 1 is that because, when performing detection of an obstruction, detection of the position of the obstruction is temporarily carried out without correcting the electric wave intensity and the position is determined from the result, subsequent corrections are adversely affected. For example, it can be considered that a correction using an obstruction which does not exist actually is made and an existing obstruction is overlooked and any correction using this obstruction fails to be made. Therefore, the accuracy of position detection results falls.

### SUMMARY OF THE INVENTION

The present invention is made in order to solve the above-mentioned problems, and it is therefore an object of the present invention to provide a position detection system, a position detection server, and a terminal which make it possible to detect the high-accuracy position of a target for positioning which moves indoors where walls and partitions mainly exist.

In accordance with the present invention, there is provided a position detection system in which a terminal which is a target for positioning measures intensity of an electric wave from each of one or more AP units arranged indoors from communications information which each of the one or more AP units transmits at regular intervals, and which performs a process of detecting a position of the terminal on a basis of the acquired intensity of the electric wave by using a position detection server, the position detection server including: an AP position storage unit for storing an AP position which is an installed position of each of the one or more AP units; an electric wave intensity history storage unit for storing a history of the intensity of the electric wave from each of the one or more AP units; an indoor map storage unit for storing map information about an indoor map including information about locations of walls; a position history storage unit for storing a history of the detected position of the terminal; a region determining means for, when receiving the intensity of the electric wave from each of the one or more AP units which is acquired by the terminal, calculating a number of walls which exist between the AP position of each of the one or more AP units which is acquired from the AP position storage unit and an immediately preceding position of the terminal which is acquired from the position history storage unit, by using the map information stored in the indoor map storage unit, for correcting the intensity of the electric wave from each of the one or more AP units on a basis of the number of walls, for calculating a distance between each of the one or more AP units and the terminal on a basis of the corrected intensity of the electric wave so as to acquire a distance range, and for determining a region which is a set of positions which falls within the acquired distance range as an existence region of the terminal; and a position detecting means for estimating a current state of the terminal on a basis of the history of the position of the terminal which is acquired from the position history storage unit, for acquiring an actionable region in which the terminal can move from the immediately preceding position on a basis of the current state of the terminal, for determining, as a primary movable region of the terminal, a portion in which the actionable region and the existence region of the terminal overlap each other, for determining, as a secondary movable region, a portion which, from the primary movable region, excludes a part which is blocked by walls when viewed from the immediately preceding position of the terminal by using the map information stored in the indoor map storage unit, for acquiring a change in the intensity of the electric wave from each of the one or more AP units from the history of the electric wave intensity stored in the electric wave intensity history storage unit, for estimating a movement direction in which the terminal is moving on a basis of the change, for narrowing the secondary movable region down to a region extending in the movement direction so as to determine the region extending in the movement direction as a tertiary movable region, and for determining the position of the terminal on a basis of the tertiary movable region.

As previously mentioned, the position detection server in accordance with the present invention corrects for the attenuation of the intensity of an electric wave from each AP unit which is caused by walls by using map information to determine a distance with a small error between each AP unit and a terminal, acquires, as an existence region of the terminal, a region of the position of the terminal in which variations are permitted to occur in the electric wave intensity due to the characteristics of the electric wave from the distance, restricts this existence region of the terminal to an actionable region of the terminal according to the state of the terminal which is estimated from a history of the position, excludes any part which is blocked by walls when viewed from the immediately preceding position of the terminal from the actionable region by using the map information to determine a movable region, and narrows this movable region down to a region extending in the direction in which the terminal is moving which is estimated from change in the electric wave intensity from a history of the electric wave intensity to determine the position of the terminal. Therefore, because there is a very-high possibility that the terminal which is the target for positioning is existing in the narrowed-down region, the position of the terminal can be detected with a high degree of precision.

Further objects and advantages of the present invention will be apparent from the following description of the preferred embodiments of the invention as illustrated in the accompanying drawings.

### BRIEF DESCRIPTION OF THE DRAWINGS

FIG. 1 is an explanatory drawing showing the whole configuration of a position detection system which is common in Embodiments 1 to 4 of the present invention;

FIG. 2 is a flow chart showing a flow of data processing carried out by a terminal and a position detection server in accordance with Embodiment 1 of the present invention;

FIG. 3 is a flow chart showing a processing procedure by a region determining unit in accordance with Embodiment 1 of the present invention;

FIG. 4 is a flow chart showing a processing procedure by a position detecting unit in accordance with Embodiment 1 of the present invention;

FIG. 5 is an explanatory drawing showing a method of determining a maximum distance which the terminal can move according to the state of the terminal;

FIG. 6 is a flow chart showing a flow of data processing carried out by a terminal and a position detection server in accordance with Embodiment 2 of the present invention;

FIG. 7 is an explanatory drawing showing the structure of a position detection system in accordance with Embodiment 3 of the present invention; and

FIG. 8 is an explanatory drawing showing the principle on which the determination of the position of terminal from electric wave intensity is based.

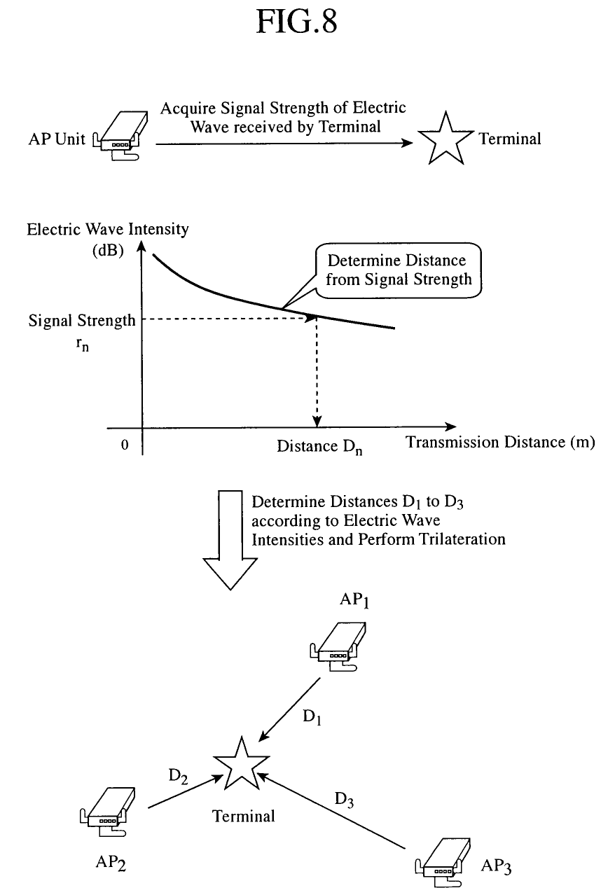

### DETAILED DESCRIPTION OF THE PREFERRED EMBODIMENTS

### Embodiment 1

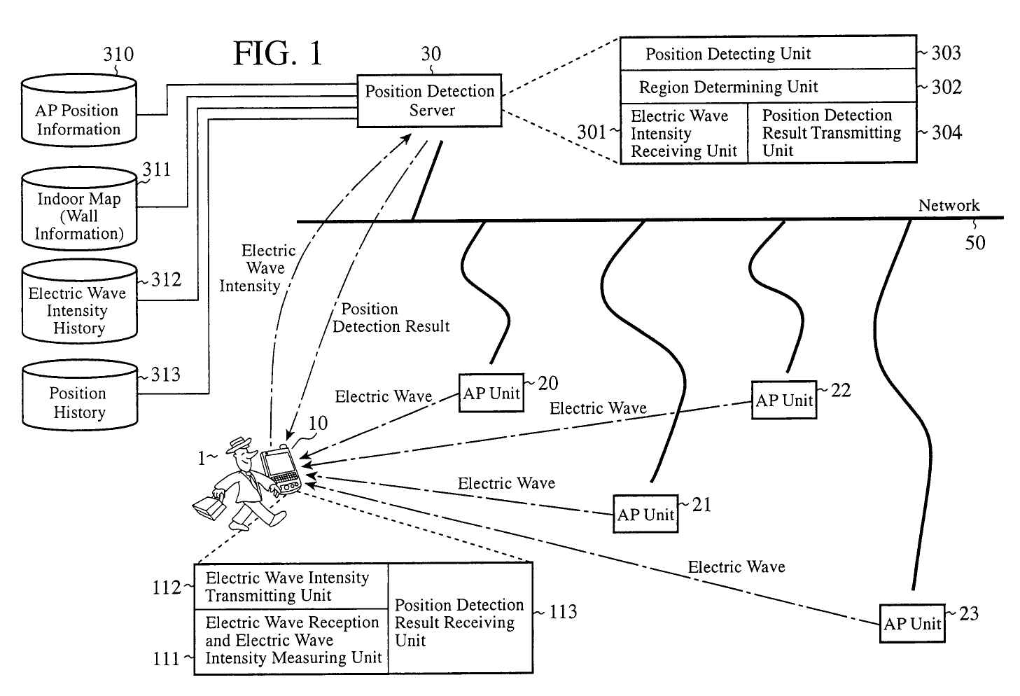

FIG. 1 is an explanatory drawing showing the whole configuration of a position detection system which is common among Embodiments 1 to 4 of the present invention. For example, a terminal 10 which a person 1 carries and which is a movable target for positioning, AP units 20, 21, 22, and 23 which are access points (AP) arranged indoors and intended for a wireless network, such as a radio LAN, and a position detection server 30 exist in an indoor environment, and the AP units 20, 21, 22, and 23 and the position detection server 30 are connected to one another via the network 50 in such a way that they can communicate with one another. Communications between the position detection server 30 and the terminal 10 can be carried out via the AP units 20, 21, 22, and 23. As an alternative, another AP unit can be disposed and used for communications between the position detection server 30 and the terminal 10. The terminal 10 is provided with an electric wave reception and electric wave intensity measuring unit 111 for receiving electric waves from the AP units 20, 21, 22, and 23, and for measuring the intensity of each of the electric waves from the AP units 20, 21, 22, and 23, an electric wave intensity transmitting unit 112 for transmitting the measured intensity of the electric wave from each of the AP units to the position detection server 30, and a position detection result receiving unit 113 for receiving the position detection results from the position detection server 30.

The position detection server 30 is provided with the following functional units: an electric wave intensity receiving unit 301 for receiving the electric wave intensity from each of the AP units which is acquired by the terminal 10; a region determining unit (a region determining means) 302 for determining an existence region in which the terminal 10 can be assumed to exist; a position detecting unit (a position detecting means) 303 for narrowing the existence region of the terminal down to a region having a high possibility that the terminal 10 is existing therein, and for estimating the position of the terminal 10; and a position detection result transmitting unit 304 for transmitting the acquired position of the terminal to the terminal 10. Furthermore, in order to store data which the position detection server uses for processing carried out by the region determining unit 302 and processing carried out by the position detecting unit 303, the position detection server 30 includes an AP position storage unit 310, an indoor map storage unit 311, an electric wave intensity history storage unit 312, and a position history storage unit 313. The AP position storage unit 310 stores information about the installed position of each of the AP units 20, 21, 22, and 23 while associating them with their AP unit IDs, respectively. The indoor map storage unit 311 stores map information about maps of the interior of a structure (including premises), the map information including location information about the locations of walls (including partitions). The electric wave intensity history storage unit 312 holds history information in which the electric wave intensity from each of the AP units acquired by the terminal is associated with a corresponding AP unit ID and a corresponding terminal ID. The position history storage unit 313 holds history information about a history of the position of the terminal which is determined by the position detecting unit 303 while associating the history information with its terminal ID.

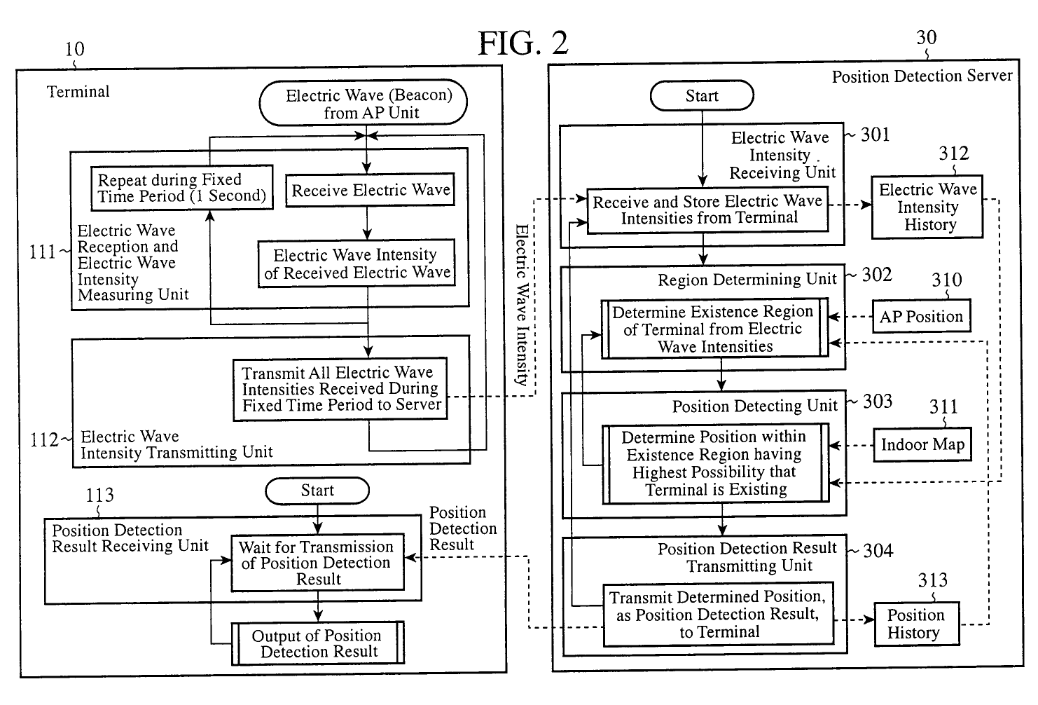

Next, the operation of the position detection system will be explained. FIG. 2 is a flow chart showing a flow of data processing carried out by the terminal 10 and the position detection server 30. It is assumed that the terminal 10 which the person 1 carries is moving indoors or has stopped somewhere indoors. Each of the AP units 20, 21, 22, and 23 sends out an electric wave at regular intervals while piggybacking beacon information on the electric wave. In the terminal 10, the electric wave reception and electric wave intensity measuring unit 111 repeats an operation of continuing receiving the electric wave from each of the AP units including the beacon information during a fixed time interval (e.g., 1 second) at fixed time intervals (e.g., every 1 second) so as to measure and hold the intensity of the electric wave from each of the AP units. After continuing receiving the electric wave from each of the AP units, the electric wave reception and electric wave intensity measuring unit 111 sends the acquired intensity of the electric wave from each of the AP units to the electric wave intensity transmitting unit 112 together with the ID of each of the AP units which has emitted the electric wave. The electric wave intensity transmitting unit 112 transmits the electric wave intensity received from each of the AP units to the position detection server 30 via the network 50.

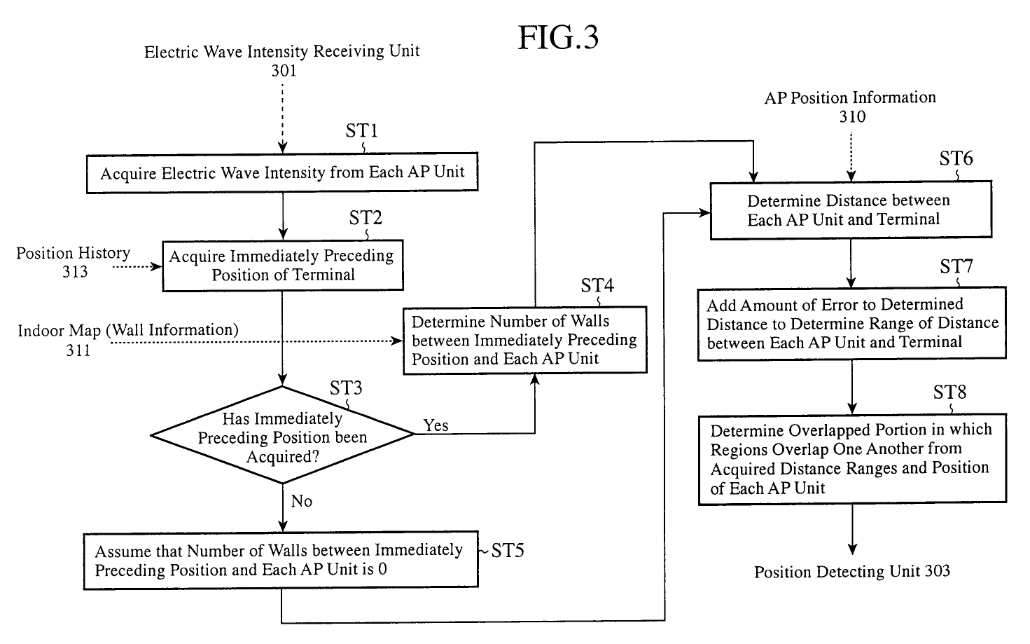

The position detection server 30 receives the intensity of the electric wave from each of the AP unit, which is sent from the terminal 10, by using the electric wave intensity receiving unit 301, and holds the electric wave intensity in the electric wave intensity history storage unit 312 and simultaneously transfers the electric wave intensity to the region determining unit 302. The region determining unit 302 corrects the received intensity of the electric wave from each of the AP units according to walls which exist between each of the AP units and the terminal 10, calculates the distance between each of the AP units and the terminal 10 on the basis of the corrected electric wave intensity, and determines a region (referred to as an existence region of the terminal from here on) in which the terminal 10 can be assumed to exist on the basis of the distance between each of the AP units and the terminal 10 which is determined and the positions of the AP units. Hereafter, the details of the process of determining the existence region of the terminal which is carried out by the region determining unit 302 will be explained with reference to a flow of FIG. 3. When the electric wave intensity receiving unit 301 receives the intensity of the electric wave from each of the AP units, the region determining unit 302 retrieves the previously-detected position of the terminal 10 (referred to as the immediately preceding position from here on) from the position history storage unit 311. When the immediately preceding position information exists in the position history storage unit, the region determining unit 302 acquires this position (step ST1). The region determining unit 302 also reads the positions of the AP units from the AP position storage unit 310. On the basis of the immediately preceding position and the AP positions which are acquired, the region determining unit 302 determines the number of walls which exist between the immediately preceding position and each of the AP units from the map information stored in the indoor map storage unit 311 (step ST3). In contrast, when, in step ST1, the immediately preceding position does not exist in the position history storage unit, the region determining unit 302 judges that no wall exists between the terminal 10 and any of the AP units (i.e., the number of walls is zero) (step ST4).

When one or more walls exist between the terminal and an AP unit, the intensity of the electric wave from the AP unit attenuates. Therefore, in order to determine the distance between each of the AP units and the terminal correctly, it is necessary to correct the intensity of the electric wave from each of the AP units to a value that ought to be obtained when no wall exists between them. After, in steps ST3 and 4, acquiring the number of walls, the region determining unit 302 corrects the intensity of the electric wave from each of the AP units on the basis of this number of walls, and determines the distance between each of the AP units and the terminal 10 on the basis of the corrected electric wave intensity (step ST5). This distance calculation is carried out by using radio propagation loss-distance characteristics as shown in “1802.11 High-speed radio LAN textbook” written by Masahiro Morikura and Shuji Kubota, Impress Corp., ISBN 4-8443-2060-2.

Next, the region determining unit 302 adds an amount of error to the distance between each of the AP units and the terminal 10 which it has acquired so as to determine a range of the distance between the terminal 10 and each of the AP units (step ST6). The amount of error which is added to the distance varies according to the determined distance. The distance range can be acquired directly from the electric wave intensity. For example, there can be a method of adding fixed values (e.g., +8 dBm) to the intensity of the electric wave from each of the AP units to calculate the upper and lower limits of the distance range. After acquiring the range of the distance between each of all the AP units and the terminal 10, the region determining unit 302 determines a set of positions which fall within the distance ranges associated with all the AP units as the existence region of the terminal (step ST7). The existence region of the terminal which the region determining unit 302 determines in the above-mentioned way is sent to the position detecting unit 303. As previously mentioned, the intensity of the electric wave which reaches the terminal from each of the AP units varies due to the characteristics of the electric wave even if the terminal is standing still. Therefore, the distance between each of the AP units and the terminal which is determined from the electric wave intensity has a fixed amount of error. As a result, the position of the terminal which is determined is not defined as a point, but is defined as a fixed region, i.e., the existence region. Therefore, it is necessary to narrow the existence region of the terminal which is acquired using the corrected degrees of electric wave intensity down to a position where the terminal for positioning actually exists.

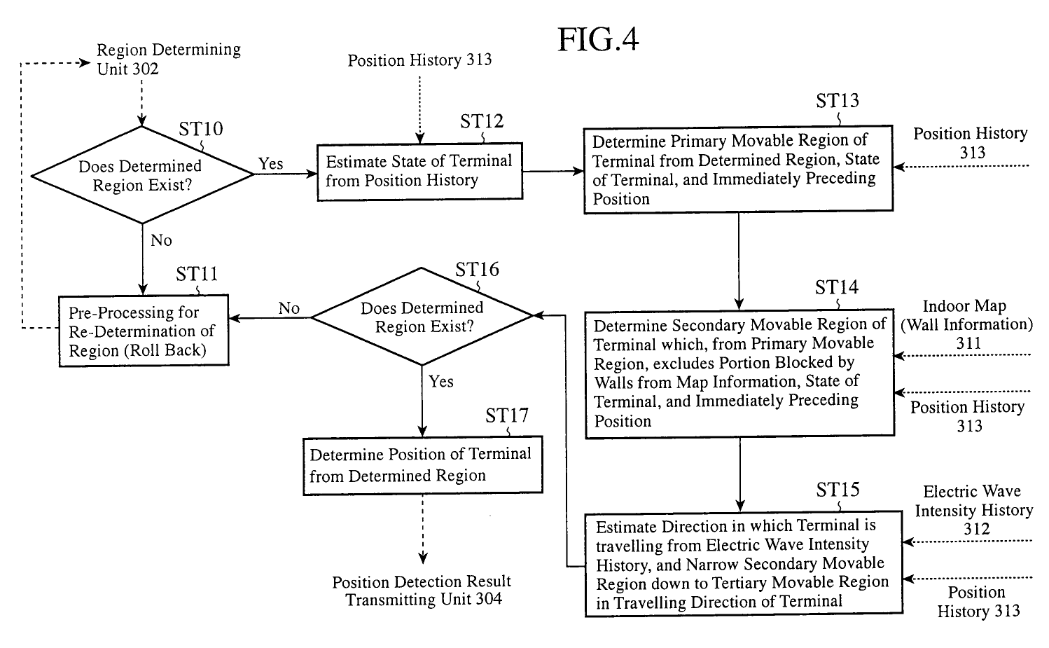

The position detecting unit 303 further narrows the existence region down to a region on the basis of the existence region of the terminal determined by the region determining unit 302, the indoor map information, the position history, and the electric wave intensity history, and then determines the position of the terminal 20 from the acquired region. Hereafter, the details of the process carried out by the position detecting unit 303 will be explained with reference to a flow of FIG. 4. When receiving the existence region of the terminal which is determined by the region determining unit 302, the position detecting unit 303 determines whether or not this region is null first (step ST10). When determining that the existence region is null, the position detecting unit 303 assumes that the calculation of the existence region has failed and returns the sequence to the region determining unit 302 to cause this region determining unit to determine the existence region again (step ST11). By assuming that the immediately preceding position information which can vary is wrong among the pieces of information (the AP positions, the wall information, and the immediately preceding position information) which are used for the calculation of the existence region, the region determining unit 302 restarts the calculation of the existence region from the calculation of the immediately preceding position of the terminal 10 in step ST2.

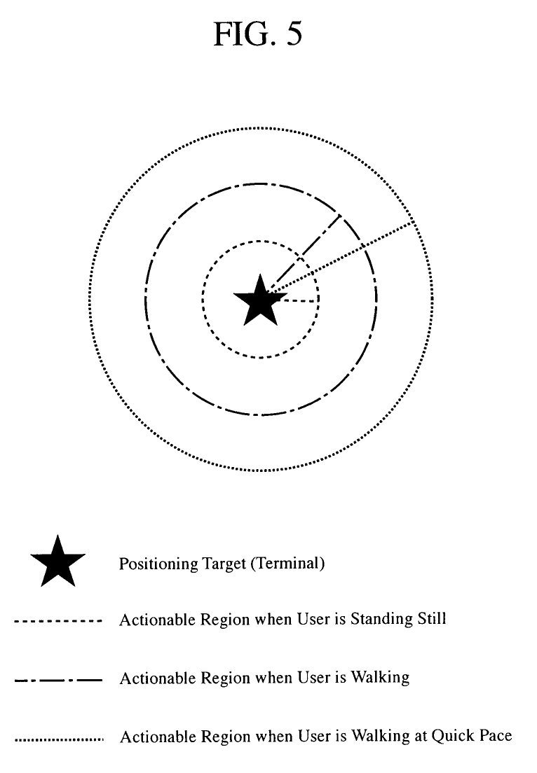

In contrast, when, in step ST10, determining that the existence region of the terminal exists, the position detecting unit 303 narrows this region down to a high-possibility region. First, the position detecting unit 303 estimates the current state of the terminal from previously-detected positions of the terminal 10 which are stored in the position history storage unit 313 (step ST12). For example, this current state of the terminal can be a state in which the terminal is standing still, a state in which the terminal is moving at a person's usual walking speed, or a state in which the terminal is moving at a person's usual running speed. The position detecting unit 303 then determines a maximum distance over which the terminal 10 can move from the immediately preceding position according to the above-mentioned current state of the terminal by using a method which is illustrated in FIG. 5, acquires an actionable region on the basis of this maximum distance, and determines, as a movable region (referred to as a primary movable region from here on) of the terminal, a portion where the actionable region and the existence region of the terminal which is delivered thereto from the region determining unit 302 overlap each other (step ST13).

The position detecting unit 303 further determines, as a movable region where the terminal can move (referred to as a secondary movable region from here on), a region which, from the primary movable region, excludes any part which is blocked by walls when viewed from the immediately preceding position of the terminal 10 by using the map information including the wall information which is stored in the indoor map storage unit 311 (step ST14). In addition, the position detecting unit 303 acquires a change in the intensity of the electric wave from each of the AP units from the electric wave intensity history stored in the electric wave intensity history storage unit 312, and then estimates whether the terminal 10 is approaching to the AP units or is moving away from the AP units, i.e., the direction in which the terminal 10 is moving on the basis of this change information. As a result, the position detecting unit 303 can recognize that there is a high possibility that the terminal has moved to which part of the above-mentioned secondary movable region. Thus, the position detecting unit 303 narrows the above-mentioned secondary movable region down to a region extending in the above-mentioned direction in which the terminal is moving so as to determine this region extending in the direction as a narrowed movable region (referred to as a tertiary movable region) of the terminal (step ST15).

When the tertiary movable region which is determined as mentioned above is null (step ST16), the position detecting unit 303 returns the sequence to the region determining unit 302 (ST11) to restart the calculation of the existence region from the calculation of the immediately preceding position of the terminal 10 in step ST2, as in the case in which the existence region acquired by the region determining unit 302 in step ST10 is null. In contrast, when, in step ST16, the determined tertiary movable region is not null, the position detecting unit 303 judges that this movable region of the terminal which is finally determined is the one having the highest possibility that the terminal has moved thereto, and determines one point in this region as the position of the terminal 10. Although there are well-known various methods as a method of determining this point, for example, a method of acquiring the center of gravity of the region as the point can be used. The number of times that the region determining unit 302, in step ST11, determines the immediately preceding position again can be restricted in order to prevent an endless loop from occurring between the region determining unit 302 and the position detecting unit 303.

The position detection result transmitting unit 304 transmits, as a position detection result, the position of the terminal 10 which the position detecting unit 303 has determined as mentioned above to the terminal 10, and also stores and holds the position of the terminal 10 in the position history storage unit 313. When the terminal 10 receives the position detection result from the position detection server 30 using the position detection result receiving unit 113, the terminal 10 displays the result properly. After that, the terminal 10 waits for transmission of the next position detection result from the position detection server 30.

As mentioned above, in accordance with this Embodiment 1, the region determining unit 302 corrects for the attenuation of the intensity of the electric wave from each AP unit which is caused by walls by using the map information to determine the distance with a small error between each AP unit and the terminal, and acquires, as an existence region of the terminal, a region of the position of the terminal in which variations are permitted to occur in the electric wave intensity due to the characteristics of the electric wave from the distance, and the position detecting unit 303 restricts this existence region of the terminal to an actionable region of the terminal according to the state of the terminal which is estimated from the position history, excludes any part which is blocked by walls when viewed from the immediately preceding position of the terminal from the actionable region by using the map information to determine a movable region, further narrows this movable region down to a region extending in the direction in which the terminal is moving which is estimated from change in the electric wave intensity from the electric wave intensity history so as to determine a further-narrowed movable region (i.e., a tertiary movable region as mentioned above), and then determines the position of the terminal on the basis of this movable region. Therefore, because the possibility that the terminal is existing in the movable region which is used for the position detection becomes very high, the position detection can be carried out with a high degree of precision. In this embodiment, the example in which the beacon of the radio LAN is used is explained. As an alternative, other electric wave devices from each of which the terminal can receive an electric wave and acquire the intensity of the electric wave, e.g., devices which comply with RFID (Radio Frequency IDdentification), Bluetooth (registered trademark), or the like can be used. In this case, each of them is constructed in such a way as to radiate an electric wave at regular intervals. The same goes for the following embodiments.

In the above-mentioned example, only the electric wave intensity and the number of walls are used for the calculation of the distance between each of the AP units 20, 21, 22, and 23 and the terminal 10. In addition, information about the material of the walls can be included into the map information stored in the indoor map storage unit 311, and the radio wave propagation loss in consideration of the materials of the walls can be reflected to correct the electric wave intensity. This is because the attenuation of the electric wave varies according to the material of the walls. Therefore, when a correction in consideration of the attenuation of the electric wave depending upon the material of the walls is made, a further improvement in the accuracy of the distance positioning can be expected. Furthermore, in the above-mentioned example, the position detection is carried out from only the relation between the positioning environment and the terminal 10. As an alternative, when measuring the number of walls, another terminal which exists in the same positioning environment can be included in the positioning environment. More specifically, when another terminal exists between the AP units and the terminal, the calculation of the distance between the terminal and each of the AP units is corrected by assuming that the terminal is equivalent to a wall. As a result, an improvement in the accuracy of the distance positioning can be expected.

### Embodiment 2

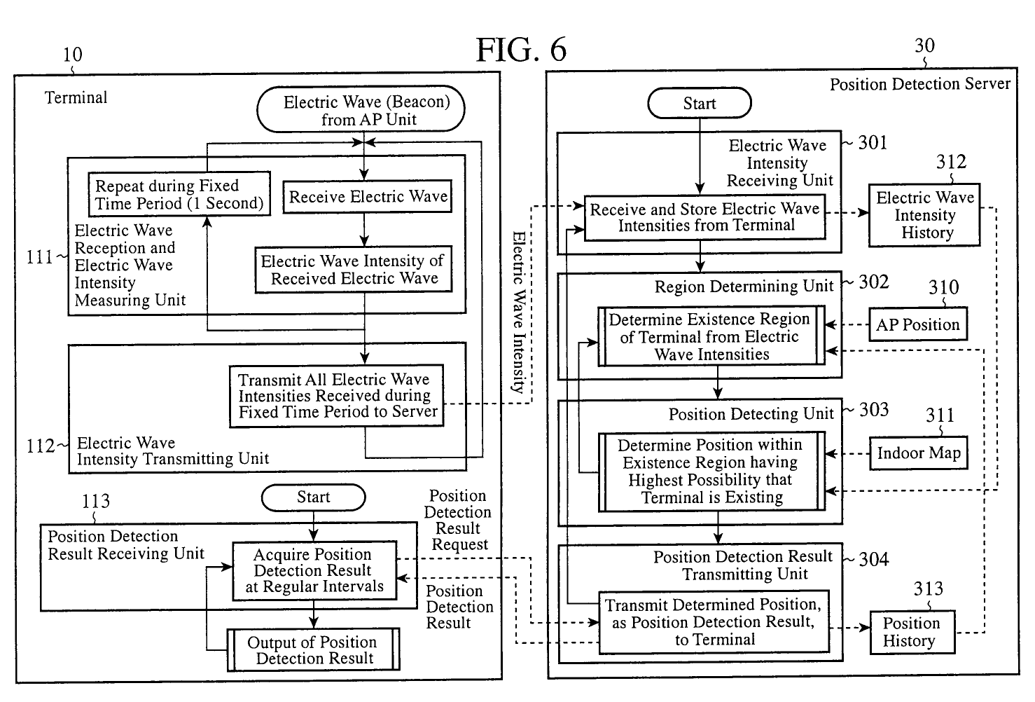

FIG. 6 is a block diagram showing the whole configuration of a position detection system in accordance with Embodiment 2 of the present invention. In the figure, the same components as those shown in FIG. 2 are designated by the same reference numerals, and the explanation of the components will be omitted hereafter in principle. In this embodiment, the processing operations of the position detection result transmitting unit 304 of the position detection server 30 and the position detection result receiving unit 113 of the terminal 10 differ from those in accordance with Embodiment 1 somewhat. That is, in accordance with Embodiment 1, the position detection server 30 is constructed in such a way as to, after performing the position detection process, transmit the position detection result to the terminal 10 properly. In contrast, in accordance with this Embodiment 2, the position detection server 30 is constructed in such a way as to simply hold the position detection result, and the terminal 10 is constructed in such a way as to make a request of the position detection server 30 to acquire the position detection result from the position detection server 30 whenever necessary. As a result, the terminal 10 does not need to wait for transmission of the position detection result from the position detection server 30, and therefore the position detection server 30 can eliminate its transmission processing.

### Embodiment 3

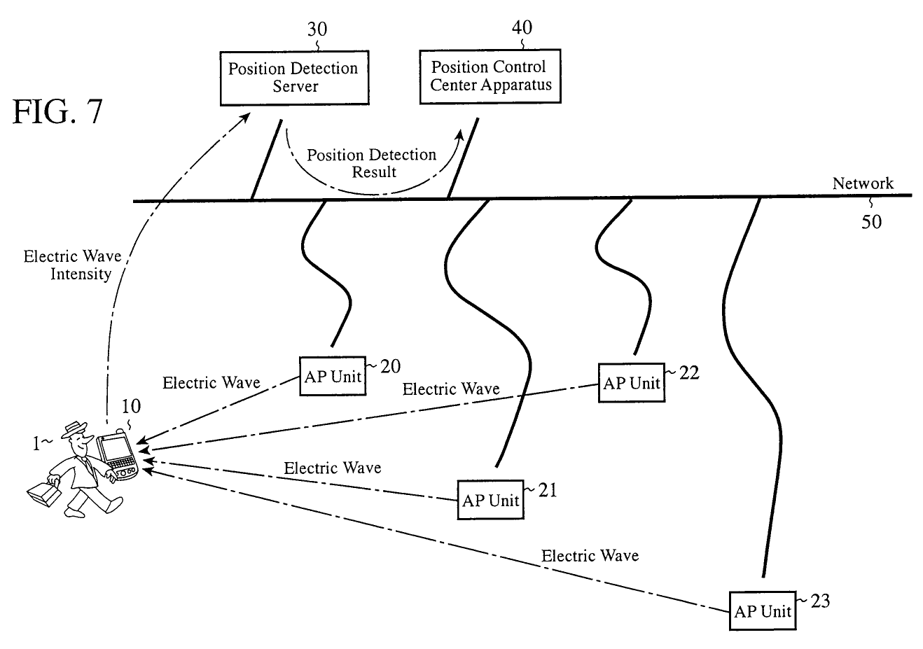

FIG. 7 is an explanatory drawing schematically showing the structure of a position detection system in accordance with Embodiment 3 of the present invention. In the figure, the same components as those shown in FIG. 1 are designated by the same reference numerals, and the explanation of the components will be omitted hereafter in principle. In this embodiment, a position control center 40 using the position detection result which is determined by the position detection server 30 is disposed. More specifically, the terminal 10 is constructed in such a way as not to acquire the position detection result determined by the position detection server 30, and the position control center 40 is constructed in such a way as to acquire the position detection result instead of the terminal 10. In this case, by acquiring the position of each of a plurality of terminals, the position control center 40 can perform monitoring and management of where each of the plurality of terminals is currently existing, what kind of motion each of the plurality of terminals is making, and so on.

### Embodiment 4

In this Embodiment 4, the position detecting functions which are carried out by the position detection server 30 in accordance with Embodiment 1, i.e., the region determining unit 302, the position detecting unit 303, the AP position storage unit 310, the indoor map storage unit 311, the electric wave intensity history storage unit 312, and the position history storage unit 313 are disposed in the terminal 10. As a result, the terminal 10 can perform detection of the position thereof independently. Furthermore, the terminal 10 does not need to carry out transmission of the intensity of the electric wave from each AP unit to the position detection server 30 and external communications other than beacon reception, unlike that of Embodiment 1.

Many widely different embodiments of the present invention maybe constructed without departing from the spirit and scope of the present invention. It should be understood that the present invention is not limited to the specific embodiments described in the specification, except as defined in the appended claims.

What is claimed is:

1. A position detection system in which a terminal which is a target for positioning measures intensity of an electric wave from each of one or more AP units arranged indoors from communications information which each of the one or more AP units transmits at regular intervals, and which performs a process of detecting a position of said terminal on a basis of the acquired intensity of the electric wave by using a position detection server, said position detection server comprising:
an AP position storage unit for storing an AP position which is an installed position of each of the one or more AP units;
an electric wave intensity history storage unit for storing a history of the intensity of the electric wave from each of the one or more AP units;
an indoor map storage unit for storing map information about an indoor map including information about locations of walls;
a position history storage unit for storing a history of the detected position of the terminal;
a region determining means for, when receiving the intensity of the electric wave from each of the one or more AP units which is acquired by said terminal, calculating a number of walls which exist between the AP position of each of the one or more AP units which is acquired from said AP position storage unit and an immediately preceding position of said terminal which is acquired from said position history storage unit, by using the map information stored in said indoor map storage unit, for correcting the intensity of the electric wave from each of the one or more AP units on a basis of said number of walls, for calculating a distance between each of the one or more AP units and said terminal on a basis of the corrected intensity of the electric wave so as to acquire a distance range, and for determining a region which is a set of positions which falls within said acquired distance range as an existence region of said terminal; and
a position detecting means for estimating a current state of said terminal on a basis of the history of the position of said terminal which is acquired from said position history storage unit, for acquiring an actionable region in which said terminal can move from the immediately preceding position on a basis of said current state of said terminal, for determining, as a primary movable region of said terminal, a portion in which said actionable region and said existence region of said terminal overlap each other, for determining, as a secondary movable region, a portion which, from the primary movable region, excludes a part which is blocked by walls when viewed from the immediately preceding position of said terminal by using the map information stored in said indoor map storage unit, for acquiring a change in the intensity of the electric wave from each of the one or more AP units from the history of the electric wave intensity stored in said electric wave intensity history storage unit, for estimating a movement direction in which said terminal is moving on a basis of said change, for narrowing said secondary movable region down to a region extending in said movement direction so as to determine said region extending in said movement direction as a tertiary movable region, and for determining the position of said terminal on a basis of said tertiary movable region.

2. The position detection system according to claim 1, wherein every time when said position detection server detects the position of said terminal, said position detection server transmits the detected position to said terminal.

3. The position detection system according to claim 1, wherein only when receiving a request from said terminal, said position detection server transmits the detected position to said terminal.

4. The position detection system according to claim 1, wherein said system has a position control center apparatus for acquiring the detected position of said terminal from said position detection server, and for managing the position of the terminal.

5. The position detection system according to claim 1, wherein said terminal which is the target for positioning has said region determining means and said position detecting means in behalf of said position detection server.

6. A position detection server which performs a process of detecting a position of a terminal which is a target for positioning on a basis of acquired intensity of an electric wave from each of one or more AP units arranged indoors, said terminal measuring the intensity of the electric wave from communications information which each of the one or more AP units transmits at regular intervals, said position detection server comprising:
an AP position storage unit for storing an AP position which is an installed position of each of the one or more AP units;
an electric wave intensity history storage unit for storing a history of the intensity of the electric wave from each of the one or more AP units;
an indoor map storage unit for storing map information about an indoor map including information about locations of walls;
a position history storage unit for storing a history of the detected position of the terminal;
a region determining means for, when receiving the intensity of the electric wave from each of the one or more AP units which is acquired by said terminal, calculating a number of walls which exist between the AP position of each of the one or more AP units which is acquired from said AP position storage unit and an immediately preceding position of said terminal which is acquired from said position history storage unit, by using the map information stored in said indoor map storage unit, for correcting the intensity of the electric wave from each of the one or more AP units on a basis of said number of walls, for calculating a distance between each of the one or more AP units and said terminal on a basis of the corrected intensity of the electric wave so as to acquire a distance range, and for calculating a region which is a set of positions which falls within said acquired distance range as an existence region of said terminal; and
a position detecting means for estimating a current state of said terminal on a basis of the history of the position of said terminal which is acquired from said position history storage unit, for acquiring an actionable region in which said terminal can move from the immediately preceding position on a basis of said current state of said terminal, for determining, as a primary movable region of said terminal, a portion in which said actionable region and said existence region of said terminal overlap each other, for determining, as a secondary movable region, a portion which, from the primary movable region, excludes a part which is blocked by walls when viewed from the immediately preceding position of said terminal by using the map information stored in said indoor map storage unit, for acquiring a change in the intensity of the electric wave from each of the one or more AP units from the history of the electric wave intensity stored in said electric wave intensity history storage unit, for estimating a movement direction in which said terminal is moving on a basis of said change, for narrowing said secondary movable region down to a region extending in said movement direction so as to determine said region extending in said movement direction as a tertiary movable region, and for determining the position of said terminal on a basis of said tertiary movable region.

7. A terminal which is a target for positioning, which measures intensity of an electric wave from each of one or more AP units arranged indoors from communications information which each of the one or more AP units transmits at regular intervals, and which performs a process of detecting a position thereof on a basis of the acquired intensity of the electric wave, said terminal comprising:
an AP position storage unit for storing an AP position which is an installed position of each of the one or more AP units;
an electric wave intensity history storage unit for storing a history of the intensity of the electric wave from each of the one or more AP units;
an indoor map storage unit for storing map information about an indoor map including information about locations of walls;
a position history storage unit for storing a history of the detected position of said terminal;
a region determining means for, when acquiring the intensity of the electric wave from each of the one or more AP units, calculating a number of walls which exist between the AP position of each of the one or more AP units which is acquired from said AP position storage unit and an immediately preceding position of said terminal which is acquired from said position history storage unit, by using the map information stored in said indoor map storage unit, for correcting the intensity of the electric wave from each of the one or more AP units on a basis of said number of walls, for calculating a distance between each of the one or more AP units and said terminal on a basis of the corrected intensity of the electric wave so as to acquire a distance range, and for determining a region which is a set of positions which falls within said acquired distance range as an existence region of said terminal; and
a position detecting means for estimating a current state of said terminal on a basis of the history of the position of said terminal which is acquired from said position history storage unit, for acquiring an actionable region in which said terminal can move from the immediately preceding position on a basis of said current state of said terminal, for determining, as a primary movable region of said terminal, a portion in which said actionable region and said existence region of said terminal overlap each other, for determining, as a secondary movable region, a portion which, from the primary movable region, excludes a part which is blocked by walls when viewed from the immediately preceding position of said terminal by using the map information stored in said indoor map storage unit, for acquiring a change in the intensity of the electric wave from each of the one or more AP units from the history of the electric wave intensity stored in said electric wave intensity history storage unit, for estimating a movement direction in which said terminal is moving on a basis of said change, for narrowing said secondary movable region down to a region extending in said movement direction so as to determine said region extending in said movement direction as a tertiary movable region, and for determining the position of said terminal on a basis of said tertiary movable region.
